(19) United States
(12) Patent Application Publication
(10) Pub. No.: US 2019/0382579 A1
(43) Pub. Date: Dec. 19, 2019

(54) Mixture of Boron Nitride Particles and Cellulose Nanocrystals and Resin Composition Containing the Mixture

(71) Applicant: 3M INNOVATIVE PROPERTIES COMPANY, St. Paul, MN (US)

(72) Inventors: Corinne E. Lipscomb, St. Paul, MN (US); Jeremy M. Higgins, Roseville, MN (US)

(21) Appl. No.: 16/470,570

(22) PCT Filed: Dec. 12, 2017
(86) PCT No.: PCT/US2017/065690

§ 371 Date: Jun. 18, 2019

Related U.S. Application Data
(60) Provisional application No. 62/436,835, filed on Dec. 20, 2016.

(51) Int. Cl. C08L 63/00; C08J 3/22

(52) U.S. Cl. CPC C08L 63/00; C08L 2205/12; C08L 2310/00; C08J 3/226

(57) ABSTRACT

A method of making a resin composition is described comprising providing a mixture of boron nitride particles and cellulose nanocrystals and combining the mixture with a resin composition. The weight ratio of boron nitride to cellulose nanocrystals typically ranges from 99.9:0.1 to 90:10. The resin composition can have a viscosity at least a 5, 10, 15, 20 or 25% lower than the same composition without the cellulose nanocrystals, which facilitate processing efficiency and is also amenable to incorporating higher boron nitride concentrations into the resin composition. Also described is a (e.g. powder) composition comprising premixed boron nitride particles and cellulose nanocrystals and resin composition comprising such (e.g. powder) composition.

### SUMMARY OF THE INVENTION

In one embodiment, a method of making a resin composition is described comprising providing a mixture of boron nitride particles and cellulose nanocrystals and combining the mixture with a resin composition. The weight ratio of boron nitride to cellulose nanocrystals typically ranges from 99.9:0.1 to 90:10.

The resin composition can have a viscosity at least a 5, 10, 15, 20 or 25% lower than the same composition without the cellulose nanocrystals, which facilitate processing efficiency and is also amenable to incorporating higher boron nitride concentrations into the resin composition.

In favored embodiments, the resin composition comprises at least substantially the same thermal properties as compared to the same composition without the cellulose nanocrystals. Further, the resin composition comprises at least substantially the same tensile and elongation properties as compared to the same composition without the cellulose nanocrystals.

In another embodiment, a powder is described comprising a mixture of boron nitride particles and cellulose nanocrystals wherein the weight ratio of hexagonal boron nitride to cellulose nanocrystals ranges from 99.9:0.1 to 90:10. In favored embodiments, the powder provides at least a 5, 10, 15, 20 or 25% decrease in viscosity when 30 wt.-% of the powder is combined with Epoxy Test Resin.

In yet another embodiment, a composition is described comprising premixed boron nitride particles and cellulose nanocrystals wherein the cellulose nanocrystals are present such that the mixture provides at least a 5, 10, 15, 20 or 25% decrease in viscosity when 30 wt.-% of the premixed boron nitride particles and cellulose nanocrystals are combined with Epoxy Test Resin.

In yet another embodiment, a resin composition is described comprising embodied the powder or composition comprising premixed boron nitride particles and cellulose nanocrystals.

### DETAILED DESCRIPTION

The present invention concerns a mixture of boron nitride particles and cellulose nanocrystals and the use of such mixture as a filler in resin compositions.

Any boron nitride particles can be combined with the cellulose nanocrystals.

Boron nitride is a heat- and chemically resistant refractory compound of boron and nitrogen with the chemical formula BN. It exists in various crystalline forms that are isoelectronic to a similarly structured carbon lattice. The hexagonal form corresponding to graphite is the most stable and soft, and is therefore used as a lubricant and an additive to cosmetic products.

As described in US2012/0114905, hexagonal boron nitride powder is synthesized industrially by nitriding boric acid in the presence of a source of nitrogen. Ammonia can be used as the source of nitrogen, and then usually calcium phosphate is used as the carrier material for the boric acid. An organic source of nitrogen such as melamine or urea can also be reacted under nitrogen with boric acid or borates. Nitriding is usually carried out at temperatures from 800 to 1200° C. The boron nitride then obtained is largely amorphous, and it is also called turbostratic boron nitride. Hexagonal, crystalline boron nitride is produced from amorphous boron nitride at higher temperatures up to about 2100° C., typically in an inert, nitrogen atmosphere. For this high-temperature treatment, crystallization additives are also added to the amorphous boron nitride.

In the high-temperature treatment, hexagonal boron nitride (hBN) is formed, as primary particles with lamellar morphology. This lamellar morphology is also referred to as platelets. Typical sizes of the lamellae are in the range from approx. 1 to 20 μm, but sizes of the lamellae up to 50 μm or more are also possible. Usually the heat-treated product is ground or deagglomerated after production, to obtain processable powder.

The thermal conductivity of hexagonal boron nitride is greater in the plane of the lamella (a-axis) than perpendicular to it (c-axis). In the direction of the c-axis the thermal conductivity is 2.0 W/mK, but in the direction of the a-axis it is 400 W/mK (see R. F. Hill, SMTA National Symposium “Emerging packaging Technologies”, Research Triangle Park, N.C., Nov. 18-21, 1996).

Boron nitride particles are commercially available from 3M Advanced Material Division, St. Paul Minn., as “3M™ Boron Nitride Cooling Filler Platelets” and “3M™ Boron Nitride Cooling Filler Agglomerates”. Such powders typically comprise >98.5% of boron nitride, <0.1% B₂O₂, <0.7% oxygen, and <0.2% carbon. The platelet material is available in several grades described in greater detail as follows:

| | | | Bulk Density | Bulk | Surface | |
|---|---|---|---|---|---|---|
| Particle size distribution | | | (Scott) | density | area | |
| d (0.1) μm | d (0.5) μm | d (0.9) μm | g/cm³ | (DIN) | m²/g | Grade |
| 1-2 | 2-6 | 8-12.5 | | </=0.15 | <20 | Platelets 003 SF |
| 1-2 | 2-6 | 10-22.5 | </=0.15 | | <20 | Platelets 003 |
| 1.5-3 | 4.5-8 | 10-20 | </=0.2 | | <10 | Platelets 006 |
| 1.5-3 | 5-8 | 10-20 | </=0.22 | | <15 | Platelets 007 HS |
| 2-3.5 | 6-9.5 | 12-25 | </=0.22 | | <10 | Platelets 0075 |
| 2-3.5 | 6-12 | 14-32 | </=0.22 | | <7 | Platelets 009 |
| 2-4.5 | 8-14 | 20-40 | </=0.25 | | <5 | Platelets 012 |
| 2-8 | 5-28 | 30-140 | | | <3.5 | Platelets 015/400 |
| | | | | | | HR |
| 65-120 | 12-190 | 200-300 | | 0.3-0.55 | <3.5 | Platelets 15/400 |

### Powder Characteristics

HR=High Reflection|SF=Super Fine|HS=High Surface

For calculation purpose: Density of bulk hBN 2.25 g/cm³

Boron nitride platelets can also be made at even smaller particle sizes than “Platelets 003 SF”. For example, formerly available “Platelets 001” had the following powder characteristics.

Powder Characteristics

| | | Bulk Density | | |
|---|---|---|---|---|
| Particle size distribution | | (Scott) | Surface area | |
| d (0.1) μm | d (0.9) μm | g/cm³ | m²/g | Grade |
| 0.3-0.5 | 0.8-1.0 | 0.05-0.1 | <25 | Platelets 001 |

Boron nitride filler is also available in the form of secondary particles formed from the primary platelet particles. “Primary particle size” refers to the mean diameter of a single (non-aggregate, non-agglomerate) particle. There are various methods for production of these secondary particles, giving granules with varying morphology and varying properties. In some embodiments, the secondary particles may be referred to as “agglomerates”. An “agglomerate” refers to a weak association between primary particles which may be held together by charge or polarity and can be broken down into smaller entities. These weakly bound agglomerates would typically break down during high energy mixing processes. In some embodiments, the agglomerate my further comprise organic or inorganic binder.

For example, US2012/0114905, incorporated herein by reference, describes boron nitride agglomerates, comprising lamellar, hexagonal boron nitride primary particles, which are agglomerated with one another with a preferred orientation, the agglomerates formed being flake-shaped. The invention also relates to a method for producing said boron nitride agglomerates, characterized in that lamellar, hexagonal boron nitride primary particles are agglomerated in such a way that they line up with one another with a preferred orientation. The flake-shaped agglomerates according to the invention are suitable as filler for polymers for making polymer-boron nitride composites and for hot pressing of boron nitride sintered compacts.

Boron nitride agglomerates are also commercially available from 3M Advanced Material Division, St. Paul Minn., as “3M™ Boron Nitride Cooling Filler Agglomerates”. The agglomerate material is available in two grades described in greater detail as follows:

Powder Characteristics

| | | | Bulk | | |
|---|---|---|---|---|---|
| | | | Density | Surface | |
| Particle size distribution | | | (DIN) | area | |
| d (0.1) μm | d (0.5) μm | d (0.9) μm | g/cm³ | m²/g | Grade |
| 5-10 | 15-30 | 35-70 | 0.1-0.4 | <3.5 | Agglomerates 50 |
| 10-50 | 55-115 | 105-205 | 0.3-0.5 | <3.5 | Agglomerates |
| | | | | | 150 |

In some embodiments, the boron nitride particles has a bulk density ranging from at least 0.05, 0.01, or 0.15 g/cm³ ranging to about 0.60 g/cm³. The surface area of the boron nitride particle can be <25, <20, <10, <5, or <3 m²/g. The surface area is typically at least 1 or 2 m²/g.

In some embodiments, the particle size, d(0.1), of the boron nitride (e.g. platelet) particles ranges from 0.25 to 100 microns, or 25 to 100 microns, or 3 to 10 microns. In some embodiments, the particle size, d(0.5), of the boron nitride (e.g. platelet) particles ranges from about 0.5 to 200 microns, or 75 to 200 microns, or 20 to 50 microns. In some embodiments, the particle size, d(0.9), of the boron nitride (e.g. platelet) particles is at least 0.5, 1, 2, 3, 4, or 5 ranging up to 300 microns, or 150 to 300 microns, or 40 to 150 microns.

In some embodiments, the particle size, d(0.1), of the boron nitride (e.g. agglomerate) particles ranges from 2 to 100 microns, or 5 to 10 microns, or 10 to 50 microns. In some embodiments, the particle size, d(0.5), of the boron nitride (e.g. agglomerate) particles ranges from about 10 to 125 microns, or 15 to 30 microns, or 50 to 125 microns. In some embodiments, the particle size, d(0.9), of the boron nitride (e.g. platelet) particles ranges from 30 to 225 microns, or 35 to 70 microns, or 90 to 225 microns.

In some embodiments, other boron nitride particles may be utilized that may have other powder charateristics than those just described.

Cellulose nanocrystals are typically extracted as a colloidal suspension by acid hydrolysis of typically chemical wood pulps, but other cellulosic materials, such as bacteria, cellulose-containing sea animals (e.g. tunicate), or cotton can be used. Cellulose nanocrystals are constituted of cellulose, a linear polymer of beta (1 to 4) linked D-glucose units, the chains of which arrange themselves to form crystalline and amorphous domains.

Cellulose nanocrystals have a unique combination of characteristics such as high axial stiffness, high tensile strength, low coefficient of thermal expansion, thermal stability up to about 300° C., high aspect ratio, low density, lyotropic liquid crystalline behavior, and shear thinning rheology in cellulose nanocrystal suspensions. Additionally, cellulose nanocrystals are renewable, sustainable, and carbon neutral, like the sources from which they are extracted.

The physical dimensions of cellulose nanocrystals can vary depending on the raw material used in the extraction. In one embodiment, the cellulose nanocrystal has an average primary particle size (maximum dimension of a cross-section of the cellulose nanocrystal, perpendicular to the length) of at least 2, 4, or even 5 nanometers (nm) and at most 10, 20, 30, or even 50 nm; and an average length (maximum dimension of the cellulose nanocrystal) of at least 50, 75, or even 100 nm and at most 150, 200, 250, 500, 750, or even 1000 nm. The cross-sectional morphology of the nanocrystals is typically rounded, but can be rectangular, or square. Typically, the cellulose nanocrystals have a high aspect ratio (ratio of height versus length). In one embodiment, the cellulose nanocrystals have an aspect ratio of 10 to 100. The cellulose nanocrystals can exits as agglomerate prior to being dispersed (in water or in the boron nitride particles). The dimensions of the cellulose nanocrystals may be determined based on transmission electron microscopy (TEM), scanning electron microscopy (SEM), atomic force microscopy, or by other suitable means. Typically, the morphology is determined on dried samples.

Cellulose nanocrystals can also characterized by high crystallinity (e.g., at least 60%, 70%, 80%, 85%, or even 90%) approaching the theoretical limit of the cellulose chains. Hydrogen bonding between cellulose chains can stabilize the local structure in cellulose nanocrystals, and plays a key role in the formation of crystalline domains. Crystallinity, defined as the crystalline fraction of the sample can influence the physical and chemical behavior of cellulose nanocrystals.

The surfaces of the cellulose nanocrystals typically comprise a plurality of functional groups, including hydroxyl and sulfate half-ester groups. In a typical embodiment, the surface of the cellulose nanocrystals are not modified as these functional groups are thought to be attracted to the (e.g. boron atom of) boron nitride. Without intending to be bound by theory, this attraction cause the cellulose nanocrystals to be associated with the boron nitride particles. However, these functional groups can optionally be modified provided that the surface modification agent comprises a functional group that is also attracted to the boron nitride. The boron nitride particles are typically not surface treated with a surface treating agent such as a silane coupling agent. However, the boron nitride particles may comprise a surface treatment provided that the cellulose nanocrystals are attracted to and associate with the boron nitride particles in a similar manner as the untreated particles thereby providing a reduction in viscosity when combined with a resin composition.

The density of the cellulose nanocrystals is typically less than 1.6, 1.4, 1.2, or even 1.1 g/cm³ at ambient conditions.

The zeta potential measures the potential difference existing between the surface of a solid particle immersed in a conducting liquid (e.g. water) and the bulk of the liquid of the cellulose nanocrystal surface. The cellulose nanocrystals have a zeta potential higher (i.e., less negative) than −50, −45, −40, −35, −30, or even −25 mV based on dynamic light scattering.

The cellulose nanocrystals typically provide a pH of less than 7.5, 7.0, 6.5, or even 6.0 and greater than 4.5, 5.0, or even 5.5 when dispersed in deionized water and measured at ambient conditions.

Based on the processing to form the cellulose nanocrystals, residual sulfur may be present. In one embodiment, the cellulose nanocrystals comprise greater than 0.01% and less than 1, 0.8, 0.5, 0.1 or even 0.05% sulfur content. An exemplary method to determine sulfur content is inductively coupled plasma.

Cellulose nanocrystals may be obtained, for example, from CelluForce, Montreal, Canada; Melodea Ltd., Israel; American Process Inc., Atlanta, Ga.; Blue Goose Biorefineries Inc., Saskatoon, Canada; and the USDA Forest Products Laboratory, Madison, Wis. via the University of Maine.

In one embodiment, a composition is described comprising a (e.g. powder) mixture of boron nitride particles and cellulose nanocrystals. A minor amount of the cellulose nanocrystals is generally combined with a major amount of boron nitride particles to form a mixture. The concentration of cellulose nanocrystals is present in a sufficient amount to provide the desired decrease in viscosity when the mixture of boron nitride particles together with the cellulose nanocrystals is combined with a resin composition. In typical embodiments, the amount of cellulose nanocrystals is at least 0.1, 0.2, 0.3, 0.4, or 0.5 wt.-% of the total of the boron nitride particles and cellulose nanocrystals.

The boron nitride particles and cellulose nanocrystals can be combined in any suitable manner.

In typical embodiments, both the boron nitride particles and the cellulose nanocrystals are provided as dry powders. These dry powders are then combined at the concentrations previously described. Suitable mixers for powder blending include planetrary mixers and ribbon-paddle blends, such as available from Ross; as well as various bladeless mixers including TURBULA™ Shaker-Mixers and dyna-MIX™ 3-dimensional rotational mixers available from Glen Mills Inc, Clifton, N.J. and SpeedMixers™, available from Flack Tek.

In some embodiments, the mixing process does not substantially change the particle size distribution of the boron nitride particles.

In other embodiments, the mixing process reduces the (e.g. agglomerate) particle size distribution of the boron nitride particles. In this embodiment, the mixture of boron nitride particles and cellulose nanocrystals can alternatively be combined with a milling apparatus. Various milling apparatus are known in the art including for example ball mills, rotary mills, and fluid air milling systems.

Although, dry-powder mixing is typically preferred, the boron nitride particles and cellulose nanocrystals can also be combined in the presence of a liquid. For example the cellulose nanocrystals may be provided as an aqueous dispersion that is added to the (e.g. dry) boron nitride particles. As yet another example, the boron nitride particles and cellulose nanocrystals can be wet milled. If higher concentration of liquids are employed, as in the case of conventional wet milling methods, the method then typically further comprises removing the liquid, for example by filtering and/or evaporation to recover a mixture wherein the cellulose nanoparticles are sufficiently associated with the boron nitride such that the mixture provide a lower viscosity (as compared to the same boron nitride without the nanocrystals) when added to a resin as previously described. In some embodiments, the liquid of the mixture is evaporated such that a free-flowing dry powder is obtained.

The cellulose nanocrystals are believed to be homogeneously distributed throughout the boron nitride particles on a macroscale. This means that if the mixture is divided into separate portions, each portion would have substantially the same concentration of boron nitride particles and cellulose nanocrystals.

The powder characteristics described above pertain to the boron nitride particles prior to being combined with cellulose nanocrystals. Without intending to be bound by theory, the primary particle size of the cellulose nanocrystals is substantially the same prior to and after combining with the boron nitride particles. In some embodiments, the particle size distribution of the boron nitride particles is also substantially the same after being combined with the cellulose nanocrystals.

In other embodiments, the particle size of the boron nitride particles is smaller as a result of the process of combining the boron nitride particles with the cellulose nanocrystals. The denisty of the mixture of the boron nitride particles and cellulose nanocrystals is typically greater than that of the boron nitride particles alone. The density can increase by 0.005, 0.001, 0.015, 0.020, 0.025, 0.030, 0.035, 0.040, 0.045, 0.050, 0.055, 0.060, 0.065 or greater. This increase in density can be primarily attributed by the process of combining the boron nitride partilces with the cellulose nanocrystals. The smaller cellulose nancrystals filling the voids between the larger boron nitride particles also contributes to the increase in density, but typically by a smaller magnitude. Although the powder charcteristics of the boron nitride particles can change as a result of mixing with the cellulose nanocrystals, the change is typcially small such that mixture falls within the same powder characteristic ranges as the boron nitride particles without the cellulose nanocrystals.

In some embodiments, the BET surface area of the mixture can be higher than the boron nitride alone. For example the BET surface area can increase by at least 0.5, 1, or 1.5 square meters/gram. In other embodiments, the change in BET surface area is less than 0.5 square meters/gram.

The premixed (e.g. powder) mixture of cellulose nanocrystals and boron nitride particles can be utilized in a variety of resin compositions as will subsequently be described. One suitable resin that may be utilized as an “Epoxy Test Resin” for evaluating the efficacy of the premixed (e.g. powder) mixture may contain a (e.g. bisphenol A-based) epoxy resin and a hardener at a weight ratio of about 8.1 to 1. The (e.g. bisphenol A-based) epoxy resin may contain 60-90 wt % of a reaction product derived from bisphenol A and epichlorohydrin, having a number average molecular weight of less than 700 grams/mole, and 10-40 wt % of a monoepoxide component, available under the trade designation EPOFIX RESIN, from Struers A/S, Ballerup, Denmark. The hardener may be a liquid amine curing agent, containing 95-100 wt % of triethylene tetramine and 0-5 wt % of water, available under the trade designation EPOFIX HARDENER, from Struers A/S, Ballerup, Denmark.

The premixed (e.g. powder) mixture of hexagonal boron nitride together with the cellulose nanocrystals can be combined with the resin composition at various concentrations. In some embodiments, the resin composition comprises at least 5, 10, 15, 20, 25, 30, 35, or 40 wt.-% of the premixed (e.g. powder) mixture. The resin composition typically comprises no greater than 80 wt.-% of the premixed (e.g. powder) mixture of hexagonal boron nitride together with the cellulose nanocrystals.

In some embodiments, the resin composition comprises no greater than 75, 70, 65, 60, 55, 50 or 45 wt.-% of the premixed (e.g. powder) mixture of hexagonal boron nitride together with the cellulose nanocrystals.

In some embodiments, the viscosity of the resin composition decreases as the concentration of cellulose nanocrystals increases. For example, in the absence of cellulose nanocrystals, the resin composition containing of boron nitride particles may have a viscosity of about 14,600 cP. However, when the boron nitride particles are premixed with 0.5 wt.-% cellulose nanocrystals prior to combining with the resin composition, the viscosity can decrease by 7% or greater. In another embodiment, wherein the boron nitride particles are premixed with 1 wt.-% cellulose nanocrystals prior to combining with the resin composition, the viscosity can decrease by 12% or greater. In yet another embodiment, when the boron nitride particles are premixed with 1 wt.-% cellulose nanocrystals prior to combining with the resin composition, the viscosity can decrease by 14% or greater. In yet another embodiment, when the boron nitride particles are premixed with 5 wt.-% cellulose nanocrystals prior to combining with the resin composition, the viscosity can decrease by 22% or greater.

The concentration of cellulose nanocrystals of the premixed powder is typically minimized such that the presence thereof does not detrimentally affect the thermal and/or tensile properties of the boron nitride particles. In some embodiments, the amount of cellulose nanocrystals is typically no greater than 10, 9.5, 9, 8.5, 8, 7.5, 7, 6.5, 6, 5.5 or 5 wt.-% of the total of the boron nitride particles and cellulose nanocrystals.

The thermal properties of the cured resin composition can be evaluated according to ASTM E1461-13 “Standard Test Method for Thermal Diffusivity by the Flash Method” (as further described in the examples). As set forth in the following examples, it has been found that the presence of the cellulose nanocrystals can reduce the viscosity of the resin composition containing the same boron nitride particles without detracting from the thermal properties. Thus, the average values of diffusivity, specific heat, and thermal conductivity are at least substantially the same, as compared to a control of the same composition without cellulose nanocrystals. By “at least” it is meant equal or better; whereas “substantially the same” means within the standard deviation or within 2 times the standard deviation,

The tensile properties of the cured resin can be evaluated according to ASTM D 638-02A: “Standard Test Method for Tensile Properties of Plastics” (as further described in the examples). As set forth in the following examples, it has been found that the presence of the cellulose nanocrystals can reduce the viscosity of the resin composition containing the same boron nitride particles without detracting from the tensile and elongation properties of the cured resin. Thus, the average values of the modulus, yield strength, % elongation and % elongation at break are at least substantially the same, as compared to a control of the same composition without cellulose nanocrystals. By “at least” it is meant equal or better; whereas “substantially the same” means within the standard deviation or within 2 times the standard deviation.

In some embodiments, such as when the concentration of cellulose nanocrystals is at least about 5 wt.-% of the mixture of boron nitride particle and cellulose nanocrystals, the modulus, yield strength and tensile strength can be improved.

The premixed (e.g. powder) mixture of boron nitride particles and cellulose nanocrystals can be used in a wide variety of resin compositions. In some embodiments, the resin composition is a thermoset resin, such an as epoxy resin.

Epoxy resin compositions generally comprise a first liquid part comprising an epoxy resin and a second liquid part comprising a curing agent. Although the first and second part are liquids at ambient temperature, the liquid parts can comprise solid components dissolved or dispersed within the liquid.

The first part of the two-part composition comprises at least one epoxy resin. Epoxy resins are low molecular weight monomers or higher molecular weight polymers which typically contain at least two epoxide groups. An epoxide group is a cyclic ether with three ring atoms, also sometimes referred to as a glycidyl or oxirane group. Epoxy resins are typically liquids at ambient temperature.

Various epoxy resins are known including for example a bisphenol A type epoxy resin, a bisphenol F type epoxy resin, a bisphenol S type epoxy resin, a phenol novolac type epoxy resin, an alkyl phenol novolac type epoxy resin, a cresol novolac type epoxy resin, a biphenyl type epoxy resin, an aralkyl type epoxy resin, a cyclopentadiene type epoxy resin, a naphthalene type epoxy resin, a naphthol type epoxy resin, an epoxy resin of condensate of phenol and aromatic aldehyde having a phenolic hydroxy group, a biphenyl aralkyl type epoxy resin, a fluorene type epoxy resin, a Xanthene type epoxy resin, a triglycidyl isocianurate, a rubber modified epoxy resin, a phosphorous based epoxy resin, and the like.

Blends of various epoxy-containing materials can also be utilized. Suitable blends can include two or more weight average molecular weight distributions of epoxy-containing compounds such as low molecular weight epoxides (e.g., having a weight average molecular weight below 200 g/mole), intermediate molecular weight epoxides (e.g., having a weight average molecular weight in the range of about 200 to 1000 g/mole), and higher molecular weight epoxides (e.g., having a weight average molecular weight above about 1000 g/mole). Alternatively or additionally, the epoxy resin can contain a blend of epoxy-containing materials having different chemical natures such as aliphatic and aromatic or different functionalities such as polar and nonpolar.

In one embodiment, the first part of the two-part composition comprises at least one bisphenol (e.g. A) epoxy resin. Bisphenol (e.g. A) epoxy resins are formed from reacting epichlorohydrin with bisphenol A to form diglycidyl ethers of bisphenol A. The simplest resin of this class is formed from reacting two moles of epichlorohydrin with one mole of bisphenol A to form the bisphenol A diglycidyl ether (commonly abbreviated to DGEBA or BADGE). DGEBA resins are transparent colorless-to-pale-yellow liquids at ambient temperature, with viscosity typically in the range of 5-15 Pa·s at 25° C. Industrial grades normally contain some distribution of molecular weight, since pure DGEBA shows a strong tendency to form a crystalline solid upon storage at ambient temperature. This same reaction can be conducted with other bisphenols, such as bisphenol F. The choice of the epoxy resin used depends upon the end use for which it is intended. Epoxides with flexibilized backbones may be desired where a greater amount of ductility is needed in the bond line. Materials such as diglycidyl ethers of bisphenol A and diglycidyl ethers of bisphenol F can provide desirable structural adhesive properties that these materials attain upon curing, while hydrogenated versions of these epoxies may be useful for compatibility with substrates having oily surfaces.

Aromatic epoxy resins can also be prepared by reaction of aromatic alcohols such as biphenyl diols and triphenyl diols and triols with epichlorohydrin. Such aromatic biphenyl and triphenyl epoxy resins are not bisphenol epoxy resins.

There are two primary types of aliphatic epoxy resins, i.e. glycidyl epoxy resins and cycloaliphatic epoxides. Glycidyl epoxy resins are typically formed by the reaction of epichlorohydrin with aliphatic alcohols or polyols to give glycidyl ethers or aliphatic carboxylic acids to give glycidyl esters. The resulting resins may be monofunctional (e.g. dodecanol glycidyl ether), difunctional (diglycidyl ester of hexahydrophthalic acid), or higher functionality (e.g. trimethylolpropane triglycidyl ether). Cycloaliphatic epoxides contain one or more cycloaliphatic rings in the molecule to which the oxirane ring is fused (e.g. 3,4-epoxycyclohexylmethyl-3,4-epoxycyclohexane carboxylate). They are formed by the reaction of cyclo-olefins with a peracid, such as peracetic acid. These aliphatic epoxy resins typically display low viscosity at ambient temperature (10-200 mPa·s) and are often used as reactive diluents. As such, they are employed to modify (reduce) the viscosity of other epoxy resins. This has led to the term ‘modified epoxy resin’ to denote those containing viscosity-lowering reactive diluents. In some embodiments, the resin composition may further comprise a reactive diluent. Examples of reactive diluents include diglycidyl ether of 1, 4 butanediol, diglycidyl ether of cyclohexane dimethanol, diglycidyl ether of resorcinol, p-tert-butyl phenyl glycidyl ether, cresyl glycidyl ether, diglycidyl ether of neopentyl glycol, triglycidyl ether of trimethylolethane, triglycidyl ether of trimethylolpropane, triglycidyl p-amino phenol, N,N′-diglycidylaniline, N,N,N′,N′,-tetraglycidyl meta-xylylene diamine, and vegetable oil polyglycidyl ether. The resin composition may comprise at least 1, 2, 3, 4, or 5 wt.-% and typically no greater than 15 or 20 wt-% of such reactive diluent(s).

In some embodiments, the resin composition comprises (e.g. bisphenol A) epoxy resin in an amount of at least about 50 wt.-% of the total resin composition including the mixture of boron nitride particles and cellulose nanocrystals. In some embodiments, the amount of (e.g. bisphenol A) epoxy resin is no greater than 95, 90, 80, 85, 80, 75, 70, or 65 wt.-% of the total resin composition.

Epoxies are typically cured with stoichiometric or near-stoichiometric quantities of curative. In the case of two-part epoxy compositions, the second part comprises the curative, also referred to herein as the curing agent. The equivalent weight or epoxide number is used to calculate the amount of co-reactant (hardener) to use when curing epoxy resins. The epoxide number is the number of epoxide equivalents in 1 kg of resin (eq/kg); whereas the equivalent weight is the weight in grams of resin containing 1 mole equivalent of epoxide (g/mol). Equivalent weight (g/mol)=1000 /epoxide number (eq/kg).

Common classes of curatives for epoxy resins include amines, amides, ureas, imidazoles, and thiols. In typical embodiments, the curing agent comprises reactive —NH groups or reactive —NR₁R₂ groups wherein R₁and R₂ are independently H or C₁ to C₄ alkyl, and most typically H or methyl.

The curing agent is typically highly reactive with the epoxide groups at ambient temperature. Such curing agents are typically a liquid at ambient temperature. However, the first curing agent can also be a solid provided it has an activation temperature at or below ambient temperature.

One class of curing agents are primary, secondary, and tertiary polyamines. The polyamine curing agent may be straight-chain, branched, or cyclic. In some favored embodiments, the polyamine crosslinker is aliphatic. Alternatively, aromatic polyamines can be utilized.

Useful polyamines are of the general formula R₅—(NR₁R₂)ₓ wherein R₁ and R₂ are independently H or alkyl, R₅ is a polyvalent alkylene or arylene, and x is at least two. The alkyl groups of R₁ and R₂ are typically C₁ to C₁₈ alkyl, more typically C₁ to C₄ alkyl, and most typically methyl. R₁and R₂ may be taken together to form a cyclic amine. In some embodiment x is two (i.e. diamine). In other embodiments, x is 3 (i.e. triamine). In yet other embodiments, x is 4.

Examples include hexamethylene diamine; 1,10-diaminodecane; 1,12-diaminododecane; 2-(4-aminophenyl)ethylamine; isophorone diamine; 4,4′-diaminodicyclohexylmethane; and 1,3-bis(aminomethyl)cyclohexane. Illustrative six member ring diamines include for example piperzine and 1,4-diazabicyclo[2.2.2]octane (“DABCO”).

Other useful polyamines include polyamines having at least three amino groups, wherein the three amino groups are primary, secondary, or a combination thereof. Examples include 3,3′-diaminobenzidine, hexamethylene triamine, and triethylene tetramine.

The specific composition of the epoxy resin can be selected based on its intended end use. For example, in one embodiment, the resin composition can be for insulation, as described in US 2014/0080940.

The resin composition may optionally further comprise additives including (e.g. silane-treated or untreated) fillers, anti-sag additives, thixotropes, processing aids, waxes, and UV stabilizers. Examples of typical fillers include glass bubbles, fumed silica, mica, feldspar, and wollastonite. In some embodiments, the resin composition further comprises other thermally conductive fillers such as aluminum oxide, aluminum hydroxide, fused silica, zinc oxide, aluminum nitride, silicon nitride, magnesium oxide, beryllium oxide, diamond, and copper.

MATERIALS

| Designation | Description |
|---|---|
| BN 1 | A boron nitride powder of highly crystalline platelets useful |
| | for thermal management applications, containing greater |
| | than 98.5% boron nitride, having a surface area of less than |
| | 25 square meters/gram, a bulk density (Scott) of 0.05 to 0.1 |
| | grams/cubic centimeter, and a particle size distribution |
| | d(0.1) of 0.3 to 0.5 micrometers and d(0.9) of 0.8 to 1.2 |
| | micrometers, obtained as 3M BORON NITRIDE |
| | COOLING FILLER PLATELETS 001 from 3M Company, |
| | St. Paul, MN. |
| BN 12 | A boron nitride powder of highly crystalline single platelets |
| | useful for thermal management applications, containing at |
| | least 98.5% boron nitride, having a surface area of less than |
| | 5 square meters/gram, a bulk density (Scott) of less than |
| | 0.25 grams/cubic centimeter, and a particle size distribution |
| | d(0.1) of 2 to 4.5 micrometers and d(0.9) of 20 to 40 |
| | micrometers, obtained as 3M BORON NITRIDE |
| | COOLING FILLER PLATELETS 012 from 3M Company, |
| | St. Paul, MN. |
| BN 75 | A boron nitride powder of highly crystalline single platelets |
| | useful for thermal management applications, containing at |
| | least 98.5% boron nitride, having a surface area of less than |
| | 10 square meters/gram, a bulk density (Scott) of 0.22 |
| | grams/cubic centimeter or less, and a particle size |
| | distribution d(0.1) of 2 to 3.5 micrometers and d(0.9) of 12 |
| | to 25 micrometers, obtained as 3M BORON NITRIDE |
| | COOLING FILLER PLATELETS 0075 from 3M |
| | Company, St. Paul, MN. |
| BN 50 A | Boron nitride based agglomerates useful for thermal |
| | management applications, containing at least 98.5% boron |
| | nitride, having a surface area of less than 3.5 square |
| | meters/gram, a bulk density (DIN) of 0.1 to 0.4 grams/cubic |
| | centimeter, and a particle size distribution d(0.1) of 5 to 10 |
| | micrometers and d(0.9) of 35 to 70 micrometers, obtained |
| | as 3M BORON NITRIDE COOLING FILLER |
| | AGGLOMERATES 50 from 3M Company, St. Paul, MN. |
| CNC | A solid white powder of cellulose nanocrystalline (CNC) |
| | particles having a primary particle size maximum |
| | dimension of 150 nanometers once dispersed (in |
| | water or in the boron nitride particles), a pH in water |
| | of 6-7, and a ionic strength of 230-270 mmol/kilogram, |
| | made by CelluForce, Montreal, Quebec, Canada. |
| | Prior to be dispersed the CNC particles can be |
| | agglomerate having a maximum dimension |
| | of 50 micrometers. |
| EPF Resin | A bisphenol A-based epoxy resin containing 60-90 wt % |
| | of a reaction product derived from bisphenol A and |
| | epichlorohydrin, having a number average molecular weight |
| | of less than 700 grams/mole, and 10-40 wt % of a |
| | monoepoxide component, available under the trade |
| | designation EPOFIX RESIN, from Struers A/S, Ballerup, |
| | Denmark. |
| EPF | A yellow liquid amine curing agent, containing |
| Hardener | 95-100 wt % of triethylene tetramine and 0-5 wt % |
| | of water, available under the trade designation |
| | EPOFIX HARDENER, from Struers A/S, |
| | Ballerup, Denmark. |
| EC 100 | A clear liquid mixture of diamines typically containing |
| Hardener | 75-81% 3,5-diethyltoluene-2,4-diamine, 18-24% 3,5- |
| | diethyltoluene-2,6-diamine, and 0.5-3% dialklylated m- |
| | phenylenediamines and having a molecular weight of 178.3, |
| | a boiling point of 555° F. (308° C.), an equivalent |
| | weight with isocyanates of 89.1 and with epoxy resins of |
| | 44.6, available under the trade designation ETHACURE |
| | 100 CURATIVE from Albemarle Corporation, |
| | Baton Rouge, LA. |

Test Methods

Viscosity

Absolute viscosity measurements were made at room temperature (20-25° C.) on a Brookfield model DV2TLVKJ0 viscometer using an LV-05 spindle at 30 revolutions per minute (rpm). Viscosities were continuously collected over 15 seconds and averaged to provide the reported values in centipoise (cP). Measurements were taken immediately after preparation of a composition. A % Viscosity Decrease relative to a control sample (containing the same boron nitride particles without cellulose nanocrystals) was calculated and reported. % Viscosity Decrease=Absolute Value of [(Sample Viscosity−Control Viscosity)/Control Viscosity)]×100.

Thermal Properties

A low speed diamond saw was used to cut disc-shaped samples measuring 2.0 millimeters thick and 12.4 millimeters in diameter from a cylindrical shaped starting material. Each disc specimen was measured for density (Archimedes Method: water displacement). The specimens were then spray coated with dgf-123 DRY GRAPHITE FILM LUBRICANT (Miracle Power Products Corporation, Cleveland, Ohio) until they were black and opaque. Along with the sample specimens, a reference sample of CORNING PYROCERAM—Glass Code 9606 (Corning Incorporated, Corning, N.Y.) was sprayed to ensure uniformity in opaqueness. All specimens were allowed to dry for one minute. Thermal diffusivity and specific heat capacity were measured using a LFA 467 HYPERFLASH—LIGHT FLASH APPARATUS (NETZSCH Instruments North America, LLC, Burlington, Mass.) according to ASTM E1461-13 “Standard Test Method for Thermal Diffusivity by the Flash Method”. For a given sample three specimens were evaluated by collecting five thermograms at each temperature point for thermal diffusivity and heat capacity calculations. The results of the three specimens were used to calculate and report an average value. In addition, the reference sample was evaluated in the same manner. Thermal conductivity (k) for each specimen was calculated as the product of the average sample thermal diffusivity (□□□alpha)), specific heat capacity (C_{P}), and density (□□□rho)), i.e.:

k=□C_{P}□

Additionally, standard deviation reported a samples thermal conductivity was calculated by propagation of component standard deviations.

Tensile Properties

Tensile properties and instrument calibration carried out generally according to ASTM D 638-02A: “Standard Test Method for Tensile Properties of Plastics” using a MTS SINTECH 10/D (MTS Systems Incorporated, Eden Prairie, Minn.) at a speed of 0.20 inches per minute. Sample edges were sanded smooth then inspected both visually and by finger to ensure that no large bubbles or grooves were present. After entering sample width and thickness, the sample was mounted in the clamps and an axial extensometer (Model 634.11 E-54; available from MTS Systems Incorporated, Eden Prairie, Minn.) was placed on the center of the specimen. The sample was then elongated and stress-strain curves obtained. The curves were used to calculate modulus, offset yield strength (at 0.2% strain), offset yield strain (at 0.2% strain), tensile strength, and elongation at break using the software provided. Three samples were evaluated and the average values reported.

Bulk Density

Bulk density was determined generally according to ASTM D7481-09: “Standard Test Methods for Determining Loose and Tapped Bulk Densities of Powders using a Graduated Cylinder”. The mass of three clean, dry, and labeled 100-mL graduated cylinders was measured to 0.1 gram. Powder was sieved through a 30 mesh (595 micrometer) screen then added to the first graduated cylinder. When between 70 to 85 milliliters of powder had been added, the volume was recorded to the nearest 1 milliliter and the mass of the cylinder was then measured to the nearest 0.1 gram. Care was taken during this process to prevent compaction as much as possible. This was repeated twice more using fresh cylinders and the same source of powder. Bulk density was calculated as: [mass of powder added]/[measured volume]. The average of the three values was reported.

Specific Surface Area by Physical Adsorption

Specimen specific surface area was determined according to ASTM C1274-12: “Standard Test Method for Advanced Ceramic Specific Surface Area by Physical Adsorption”. A freshly washed and dried sample tube (Micromeritics Instrument Corporation, Norcross, Ga.) and volume displacement insert (Micromeritics Instrument Corporation, Norcross, Ga.) were massed to the nearest 0.1 mg. The space filler was removed and powder under test was added to the round bottom flask with the aid of long stem funnel to fill the bulb of the sample tube approximately ½ full by volume. The volume insert was then added back into the sample tube, and the mass of the sample tube, insert, and powder was taken to the nearest 0.1 mg. The sample tube was attached to the drying unit of a Micromeritics ASAP 2020 Accelerated Surface Area and Porosimetry System (Micromeritics Instrument Corporation, Norcross, Ga.) and heated to 150° C. under vacuum for 2 hours. After drying, the sample tube was removed from the instrument and its mass was taken to the nearest 0.1 mg. The flask was then attached to the test port of the Micromeretic Surface Area Analyzer. Nitrogen gas adsorption measurements were taken at eleven relative pressures from 0.050 to 0.300 in steps of 0.025. A multipoint BET calculation was then completed on these data to obtain the specific surface area. A final mass of the sample tube, insert, and powder was taken to ensure minimal mass change over the course the measurement.

### EXAMPLES 1-3 AND COMPARATIVE EXAMPLE 1

Powder Compositions P1-P4

Various powder ratios of CNC and BN 12 were prepared using the amounts shown in Table 1 in parts by weight (pbw). The CNC and BN 12 powder(s) were added to a MAX 100 SPEEDMIXER cup (FlackTek, Incorporated, Landrum, S.C.), the lid secured, the cup placed in a Model DAC 400.2 VAC-P Speed Mixer (FlackTek, Incorporated, Landrum, S.C.), and the powder(s) mixed for four 15 second periods at 3000 rpm, with one minute between each period. After mixing, the powder(s) was (were) allowed to cool for 10 minutes at room temperature (20-25° C.).

TABLE 1
Powder Compositions P1-P4

| | BN 12 | CNC | Wt % | Wt % |
|---|---|---|---|---|
| Example | (pbw) | (pbw) | BN 12 | CNC |
| P1 | 50.00 | 0.00 | 100 | 0.0 |
| P2 | 49.75 | 0.25 | 99.5 | 0.5 |
| P3 | 49.50 | 0.50 | 99.0 | 1.0 |
| P4 | 98.00 | 2.00 | 98.0 | 2.0 |

### CURABLE COMPOSITIONS FOR EXAMPLES 1-3 AND COMPARATIVE EXAMPLE 1

Various resin/powder mixtures were prepared using the materials and amounts (in parts by weight (pbw)) shown in Table 2. EPF Resin and one of the powder compositions P1-P4 were added to a MAX 100 SPEEDMIXER cup and slowly mixed using a wood tongue depressor until no dry powder was visible in the resin. The resin/powder mixture was then thoroughly dispersed at 2500 rpm for one minute using the FlackTek Speed Mixer (described above). The mixture was checked to ensure dispersion quality (i.e. smooth and uniform appearing). Next, the mixture was placed in an oil bath at 80° C. to lower the viscosity of the dispersion then degassed in a small desiccator using occasional manual agitation for 10 minutes at which time the pressure was less than 0.50 Torr (67 Pascals). The mixture was then cooled to about 95° F. (35° C.) with aid of a water bath. The viscosity of the Resin/Powder mixture was then measured as described in the test method above. The results are shown in Table 3 below.

TABLE 2
Resin/Powder Mixtures

| Example | Resin (pbw) | Powder Composition | Powder (pbw) |
|---|---|---|---|
| C1 | 62.5 | P1 | 30.0 |
| 1 | 62.5 | P2 | 30.0 |
| 2 | 62.5 | P3 | 30.0 |
| 3 | 62.5 | P4 | 30.0 |

TABLE 3
Viscosity

| | Wt. | Wt. % CNC in | Brookfield Viscosity | % Viscosity |
|---|---|---|---|---|
| Example | % Filler | Filler Mixture | (cP) | Decrease |
| C1 | 30 | 0.0 | 16947 | 0 |
| 1 | 30 | 0.5 | 14227 | 16.1 |
| 2 | 30 | 1.0 | 15440 | 8.9 |
| 3 | 30 | 2.0 | 13733 | 19.0 |

These resin/powder mixtures were used to prepare curable compositions using the amounts and materials shown in Table 4 in the following manner. To the resin/powder mixtures thus prepared was added EPF Hardener. The formulations were mixed using a FlackTek Speed Mixer at 800 rpm for one minute followed by degassing under vacuum for between 10 and 15 minutes at which time the pressure was less than 0.50 Torr (67 Pascals). Curable compositions were thereby provided.

TABLE 4
Curable Compositions for Examples 1-3 and Comparative Example 1

| | Resin/Powder | EPF | | | Wt. % | |
|---|---|---|---|---|---|---|
| | Mixture | Hardener | Powder | Powder | Resin/Hardener | Wt. % |
| Example | (pbw) | (pbw) | Composition | (pbw) | Formulation | Powder |
| C1 | 92.5 | 7.5 | P1 | 30.0 | 70 | 30 |
| 1 | 92.5 | 7.5 | P2 | 30.0 | 70 | 30 |
| 2 | 92.5 | 7.5 | P3 | 30.0 | 70 | 30 |
| 3 | 92.5 | 7.5 | P4 | 30.0 | 70 | 30 |

Cured Compositions

All molding and curing of the curable compositions prepared above was done within one hour of adding the hardener to the compositions. Curable compositions were cured in a mold as follows. Two glass plates measuring 5 inches by 7 inches (12.7 centimeters by 17.8 centimeters), previously treated with release coating, were clipped together with a 0.125 inch (0.32 centimeter) thick, “U” shaped, butyl rubber spacer gasket between the plates such that one of the long edges was open. The mold was carefully filled with a curable composition to avoid entrapment of air. In addition, curable compositions were carefully added to 6 milliliter syringes having an internal diameter of 12.4 millimeters. The filled plate and syringe molds were placed in a test tube rack and degassed in a large dessicator for five minutes at which time the pressure was about 1.50 Torr (200 Pascals). After removal from the dessicator the molds were allowed to harden overnight at room temperature then cured in an oven at 80° C. for six hours. The cured compositions thus obtained were evaluated for thermal and tensile properties as described in the test methods above. The results are shown in Tables 5 and 6 below. The thermal properties were also evaluated at temperatures of 50 and 100° C. and also did not exhibit any statistical difference between Comparative Example 1 and Examples 1-3.

TABLE 5
Thermal Properties

| | | | | | Specific | | | |
|---|---|---|---|---|---|---|---|---|
| | | Density | Diffusivity | | Heat | | | |
| | | grams/cc | square | | Capacity | | Thermal | |
| | Temp | (Standard | millimeter/ | Standard | Joules/K/ | Standard | Conductivity | Standard |
| Example | (° C.) | Deviation) | second | Deviation | gram | Deviation | Watts/meter - K | Deviation |
| CE 1 | 25 | 1.356 | 0.580 | 0.010 | 1.123 | 0.111 | 0.883 | 0.100 |
| | | (0.071) | | | | | | |
| 1 | 25 | 1.348 | 0.549 | 0.039 | 1.148 | 0.024 | 0.849 | 0.070 |
| | | (0.0420) | | | | | | |
| 2 | 25 | 1.347 | 0.534 | 0.025 | 1.126 | 0.072 | 0.809 | 0.070 |
| | | (0.017) | | | | | | |
| 3 | 25 | 1.350 | 0.623 | 0.019 | 1.126 | 0.080 | 0.948 | 0.080 |
| | | (0.060) | | | | | | |

TABLE 6
Tensile Properties

| | | Yield | | | | | |
|---|---|---|---|---|---|---|---|
| | Modulus | Strength | % Elongation | | | | |
| | ksi | ksi | at Yield | Tensile | | | |
| | (Standard | (Standard | (Standard | Strength | Standard | % Elongation | Standard |
| Example | Deviation) | Deviation) | Deviation) | psi | Deviation | at Break | Deviation |
| CE1 | 873 | 4.675 | 0.70% | 5.443 | 0.239 | 1.10% | 0.10% |
| | (21) | (0.097) | (0.00) | | | | |
| 1 | 855 | 4.675 | 0.70% | 5.311 | 0.263 | 1.10% | 0.20% |
| | (15) | (0.092) | (0.00) | | | | |
| 2 | 873 | 4.792 | 0.70% | 5.503 | 0.201 | 1.10% | 0.10% |
| | (12) | (0.006) | (0.10) | | | | |
| 3 | 869 | 4.827 | 0.80% | 5.772 | 0.116 | 1.30% | 0.10% |
| | (12) | (0.067) | (0.10) | | | | |

### EXAMPLE 4 AND COMPARATIVE EXAMPLE 2

Powder Compositions P5 and P6

Powder Compositions P5 and P6, containing different ratios of CNC and BN 12, were prepared using the amounts shown in Table 7 in the same manner as described for Powder Compositions 1-4 with the following modifications.

TABLE 7
Powder Compositions P5 and P6

| | BN 12 | CNC | Wt. % | Wt. % |
|---|---|---|---|---|
| Example | (pbw) | (pbw) | BN 12 | CNC |
| P5 | 100 | 0 | 100 | 0 |
| P6 | 97.5 | 2.5 | 97.5 | 2.5 |

Curable Compositions for Example 4 and Comparative Example 2

To a MAX 200 SPEEDMIXER cup were added 157.8 pbw of EPF Resin and 34.7 pbw of EC 100 Hardener. This was mixed at 800 rpm for one minute using the FlackTek Speed Mixer (described above). The resulting resin/hardener blend was then used to prepare curable compositions using the materials and amounts (in parts by weight (pbw)) shown in Table 8. The resin/hardener blend and powder compositions P5 and P6 were added to a MAX 100 SPEEDMIXER cup and slowly mixed using a wood tongue depressor until no dry powder was visible in the resin. The resin/hardener/powder mixtures were then thoroughly dispersed using the FlackTek Speed Mixer at 2000 rpm for 30 seconds then at 2500 rpm for two 30 second periods, with five minutes between each period. The mixtures were checked to ensure dispersion quality (i.e. smooth and uniform). Curable compositions were thereby provided. The viscosity of the curable compositions was measured as described in the test method above with the following modification. A speed of 5 rpm was used. The results are shown in Table 9 below.

TABLE 8
Curable Compositions for Example 4 and Comparative Example 2

| | Resin/Hardener | | | | |
|---|---|---|---|---|---|
| | Blend | Powder | Powder | Wt. % | Wt. % |
| Example | (pbw) | Composition | (pbw) | Blend | Powder |
| C2 | 60.0 | P5 | 40.0 | 60 | 40 |
| 4 | 60.0 | P6 | 40.0 | 60 | 40 |

TABLE 9
Viscosity

| | | Wt. % CNC | Brookfield | |
|---|---|---|---|---|
| | | in Filler | Viscosity | % Viscosity |
| Example | Wt. % Filler | Mixture | (cP) | Decrease |
| C2 | 40 | 0 | 99,687 | 0 |
| 4 | 40 | 2.5 | 78,560 | 21.2 |

Cured Compositions

All molding and curing of the curable compositions prepared above was done within 12 hours of adding the hardener to the compositions. Prior to addition to the mold the curable compositions were degassed using the FlackTek Speedmixer (described above) and a vacuum. The curable compositions were mixed at 800 rpm for 5 seconds at ambient pressure, then for 9 minutes and 50 seconds at 10 milliBar (1000 Pascals), and finally for 5 seconds at ambient pressure. The curable compositions were then poured into the same type of plate molds as described for Example 1 and into small glass vials having an internal diameter of 12.5 millimeters; these were positioned in a test tube rack, then placed into an oven and cured using the following procedure: heat to 75° C. over 5 minutes, hold for two hours, heat to 125° C. over five minutes, hold for one hour, heat to 150° C. in 5 minutes, hold for 1 hour, then allowed cool to room temperature in the oven after heating was discontinued. The cured compositions thus obtained were evaluated for thermal and tensile properties as described in the test methods above. The results are shown in Tables 10 and 11 below.

TABLE 10
Thermal Properties

| | | | | | Specific | | | |
|---|---|---|---|---|---|---|---|---|
| | | Density | Diffusivity | | Heat | | | |
| | | g/cc | square | | Capacity | | Thermal | |
| | Temp | (Standard | millimeter/ | Standard | Joules/K/ | Standard | Conductivity | Standard |
| Example | (° C.) | Deviation) | second | Deviation | gram | Deviation | Watts/meter - K | Deviation |
| CE 2 | 25 | 1.422 | 0.919 | 0.003 | 1.318 | 0.025 | 1.723 | 0.034 |
| | | (0.001) | | | | | | |
| 4 | 25 | 1.419 | 0.888 | 0.006 | 1.377 | 0.017 | 1.736 | 0.024 |
| | | (0.002) | | | | | | |

TABLE 11
Tensile Properties

| | | Yield | | | | | |
|---|---|---|---|---|---|---|---|
| | Modulus | Strength | % Elongation | | | | |
| | ksi | ksi | at Yield | Tensile | | | |
| | (Standard | (Standard | (Standard | Strength | Standard | % Elongation | Standard |
| Example | Deviation) | Deviation) | Deviation) | (ksi) | Deviation | at Break | Deviation |
| CE2 | 1042 | 5.356 | 0.70% | 6.033 | 0.072 | 0.93% | 0.04% |
| | (24) | (0.117) | (0.00) | | | | |
| 4 | 987 | 5.218 | 0.73% | 5.999 | 0.087 | 1.06% | 0.10% |
| | (27) | (0.036) | (0.06) | | | | |

### EXAMPLE 5 AND COMPARATIVE EXAMPLES 3 AND 4

Powder Compositions P7 and P8

Powder Compositions P7 and P8, containing different ratios of CNC and BN 12, were prepared using the amounts shown in Table 12 in the same manner as described for Powder Compositions 1-4 with the following modifications. A MAX 100 SPEEDMIXER cup was employed and the mixing speed was 2000 rpm.

Powder Composition P9

Powder Composition P9, containing CNC and BN 12, was prepared using the amounts shown in Table 12 in the same manner as described for Powder Compositions P7 and P8 with the following modification. A first SPEEDMIXER cup containing BN 12 was mixed as described for Powder Compositions P7 and P8. This was designated CUP 1. A second SPEEDMIXER cup containing CNC was mixed as described for Powder Compositions P7 and P8. This was designated CUP 2. Materials from these two cups were then used to prepare Comparative Example 4 as described below.

TABLE 12
Powder Compositions P7-P9

| | BN 12 | CNC | Wt. % | Wt. % |
|---|---|---|---|---|
| Example | (pbw) | (pbw) | BN 12 | CNC |
| P7 | 50 | 0 | 100 | 0 |
| P8 | 49 | 1 | 98 | 2 |
| P9 - CUP 1 | 50 | 0 | 100 | 0 |
| P9 - CUP 2 | 0 | 50 | 0 | 100 |
| P9 | 49 | 1 | 98 | 2 |

Curable Compositions for Example 5 and Comparative Examples 3 and 4

To a MAX 200 SPEEDMIXER cup were added 126.2 pbw of EPF Resin and 27.8 pbw of EC 100 Hardener. This was mixed at 800 rpm for one minute using the FlackTek Speed Mixer (described above). The resulting resin/hardener blend was then used to prepare curable compositions using the materials and amounts (in parts by weight (pbw)) shown in Table 13. The resin/hardener blend and powder compositions P7 and P8 were added to a MAX 100 SPEEDMIXER cup and slowly mixed using a wood tongue depressor until no dry powder was visible in the resin. For Comparative Example 4, material from CUP 1 and CUP 2 of Powder Composition 9 in a ratio of 98:2 was added to the resin/hardener blend. The resin/hardener/powder mixtures were then thoroughly dispersed using the FlackTek Speed Mixer at 2400 rpm for one minute. The mixtures were checked to ensure dispersion quality (i.e. smooth and uniform). Curable compositions were thereby provided. The viscosity of the curable compositions was measured as described in the test method above with the following modification. A speed of 50 rpm was used. The results are shown in Table 14 below.

TABLE 13
Curable Compositions for Example 5 and
Comparative Examples 3 and 4

| | Resin/Hardener | | | | |
|---|---|---|---|---|---|
| | Blend | Powder | Powder | Wt. % | Wt. % |
| Example | (pbw) | Composition | (pbw) | Blend | Powder |
| C3 | 70.0 | P7 | 30.0 | 70 | 30 |
| C4 | 70.0 | P9 | 30.0 | 70 | 30 |
| 5 | 70.0 | P8 | 30.0 | 70 | 30 |

TABLE 14
Viscosity

| | Wt. | Wt. % | Brookfield | Premix | |
|---|---|---|---|---|---|
| | % | CNC in Filler | Viscosity | of BN | % Viscosity |
| Example | Filler | Mixture | (cP) | and CNC | Decrease |
| C3 | 30 | 0 | 4,936 | No | 0 |
| C4 | 30 | 2 | 5,200 | No | No viscosity |
| | | | | | decrease |
| 5 | 30 | 2 | 4,336 | Yes | 12.2 |

Cured Compositions

Since no viscosity drop was observed when the BN and CNC components were not pre-mixed before addition to the resin/hardener, no further molding, curing, or testing was done on these curable compositions.

### EXAMPLES 6-8 AND COMPARATIVE EXAMPLE 5

Powder Compositions P10-P13

Powder Compositions P10-P13, containing CNC and BN 75, were prepared using the amounts shown in Table 15 in the same manner as described for Powder Compositions P7and P8 with the following modification. A MAX 100 SPEEDMIXER cup was used.

TABLE 15
Powder Compositions P10-13

| | BN 75 | CNC | Wt. % | Wt. % |
|---|---|---|---|---|
| Example | (pbw) | (pbw) | BN 75 | CNC |
| P10 | 50.0 | 0.0 | 100 | 0 |
| P11 | 49.5 | 0.5 | 99 | 1 |
| P12 | 49.0 | 1.0 | 98 | 2 |
| P13 | 47.5 | 2.5 | 95 | 5 |

Curable Compositions for Examples 6-8 and Comparative Example 5

To a MAX 200 SPEEDMIXER cup were added 126.2 pbw of EPF Resin and 27.8 pbw of EC 100 Hardener. This was used to prepare curable compositions in the same manner as described for Example 4 and Comparative Example 2 using the materials and amounts shown in Table 16 with the following modification. Powder Compositions P10-P13 were employed. Curable compositions were thereby provided. The viscosity of the curable compositions was measured as described in the test method above with the following modification. A speed of 50 rpm was used. The results are shown in Table 17 below.

TABLE 16
Curable Compositions for Examples 6-8 and
Comparative Example 5

| | Resin/Hardener | | | | |
|---|---|---|---|---|---|
| | Blend | Powder | Powder | Wt. % | Wt. % |
| Example | (pbw) | Composition | (pbw) | Blend | Powder |
| C5 | 70.0 | P10 | 30.0 | 70 | 30 |
| 6 | 70.0 | P11 | 30.0 | 70 | 30 |
| 7 | 70.0 | P12 | 30.0 | 70 | 30 |
| 8 | 70.0 | P13 | 30.0 | 70 | 30 |

TABLE 17
Viscosity

| | | Wt. % | Brookfield | |
|---|---|---|---|---|
| | Wt. % | CNC in Filler | Viscosity | % Viscosity |
| Example | Filler | Mixture | (cP) | Decrease |
| C5 | 30 | 0 | 7,944 | 0 |
| 6 | 30 | 1 | 7,552 | 4.9 |
| 7 | 30 | 2 | 7,536 | 5.1 |
| 8 | 30 | 5 | 7,248 | 8.8 |

Cured Compositions

All molding and curing of the curable compositions prepared above was done within 12 hours of adding the hardener to the compositions. The curable compositions of Example 7 and Comparative Example 5 were used to prepare cured compositions in the same manner as described for Example 4 and Comparative Example 2. The cured compositions thus obtained were evaluated for thermal and tensile properties as described in the test methods above. The results are shown in Tables 18 and 19 below.

TABLE 18
Thermal Properties

| | | | | Specific | | | |
|---|---|---|---|---|---|---|---|
| | | Density | Diffusivity | Heat | | | |
| | | grams/cc | square | Capacity | | Thermal | |
| | Temp | (Standard | millimeter/ | Joules/K/ | Standard | Conductivity | Standard |
| Example | (° C.) | Deviation) | second | gram | Deviation | Watts/meter - K | Deviation |
| CE 5 | 25 | 1.335 | 0.639 | 1.204 | 0.019 | 1.03 | 0.018 |
| | | (0.004) | (0.005) | | | | |
| 7 | 25 | 1.329 | 0.638 | 1.187 | 0.014 | 1.01 | 0.013 |
| | | (0.002) | (0.002) | | | | |

TABLE 19
Tensile Properties

| | | Yield | | | | | |
|---|---|---|---|---|---|---|---|
| | Modulus | Strength | % Elongation | | | | |
| | ksi | ksi | at Yield | Tensile | | | |
| | (Standard | (Standard | (Standard | Strength | Standard | % Elongation | Standard |
| Example | Deviation) | Deviation) | Deviation) | ksi | Deviation | at Break | Deviation |
| CE 5 | 825 | 5.260 | 0.80% | 6.362 | 0.031 | 1.49% | 0.13% |
| | (6) | (0.024) | (0.00) | | | | |
| 7 | 821 | 5.223 | 0.87% | 6.285 | 0.045 | 1.38% | 0.07% |
| | (20) | (0.032) | (0.06) | | | | |

### EXAMPLES 9-11 AND COMPARATIVE EXAMPLE C6

Powder Compositions P14-P17

Powder Compositions P14-P17, containing CNC and BN 50 A, were prepared using the amounts shown in Table 20 in the same manner as described for Powder Compositions P10-P13.

TABLE 20
Powder Compositions P14-P17

| | BN 50 A | CNC | Wt. % | Wt. % |
|---|---|---|---|---|
| Example | (pbw) | (pbw) | BN 50 A | CNC |
| P14 | 50.0 | 0.0 | 100 | 0 |
| P15 | 49.5 | 0.5 | 99 | 1 |
| P16 | 49.0 | 1.0 | 98 | 2 |
| P17 | 47.5 | 2.5 | 95 | 5 |

Curable Compositions for Examples 9-11 and Comparative Example 6

Curable compositions were prepared in the same manner as described for Examples 6-8 and Comparative Example 5 using the materials and amounts shown in Table 21 with the following modification. Powder Compositions P14-P17 were employed. Curable compositions were thereby provided. The viscosity of the curable compositions was measured as described in the test method above with the following modification. A speed of 50 rpm was used. The results are shown in Table 21 below.

TABLE 20
Curable Compositions for Examples 9-10 and
Comparative Example 6

| | Resin/Hardener | Powder | Powder | Wt. % | Wt. % |
|---|---|---|---|---|---|
| Example | Blend (pbw) | Composition | (pbw) | Blend | Powder |
| C6 | 70.0 | P14 | 30.0 | 70 | 30 |
| 9 | 70.0 | P15 | 30.0 | 70 | 30 |
| 10 | 70.0 | P16 | 30.0 | 70 | 30 |
| 11 | 70.0 | P17 | 30.0 | 70 | 30 |

TABLE 21
Viscosity

| | | Wt. % | | |
|---|---|---|---|---|
| | | CNC in | | Viscosity |
| | Wt. % | Filler | Brookfield Viscosity | Decrease |
| Example | Filler | Mixture | (cP) | (%) |
| C6 | 30 | 0 | 4,184 | 0 |
| 9 | 30 | 1 | 3,816 | 8.8 |
| 10 | 30 | 2 | 3,656 | 12.6 |
| 11 | 30 | 5 | 3,608 | 13.8 |

Cured Compositions

All molding and curing of the curable compositions prepared above was done within twelve hours of adding the hardener to the compositions. The curable compositions of Example 10 and Comparative Example 6 were used to prepare cured compositions in the same manner as described for Example 4 and Comparative Example 2. The cured compositions thus obtained were evaluated for thermal and tensile properties as described in the test methods above. The results are shown in Tables 23 and 24 below.

TABLE 23
Thermal Properties

| | | | Diffusivity | | | | |
|---|---|---|---|---|---|---|---|
| | | | square | Specific | | | |
| | | Density | millimeter/ | Heat | | | |
| | | grams/cc | second | Capacity | | Thermal | |
| | Temp | (Standard | (Standard | Joules/K/ | Standard | Conductivity | Standard |
| Example | (° C.) | Deviation) | Deviation) | gram | Deviation | Watts/meter - K | Deviation |
| CE 6 | 25 | 1.329 | 0.586 | 1.188 | 0.016 | 0.93 | 0.048 |
| | | (0.011) | (0.029) | | | | |
| 10 | 25 | 1.317 | 0.536 | 1.267 | 0.021 | 0.89 | 0.093 |
| | | (0.020) | (0.054) | | | | |

TABLE 24
Tensile Properties

| | | Yield | | | | | |
|---|---|---|---|---|---|---|---|
| | Modulus | Strength | % Elongation | | | | |
| | ksi | ksi | at Yield | Tensile | | | |
| | (Standard | (Standard | (Standard | Strength | Standard | % Elongation | Standard |
| Example | Deviation) | Deviation) | Deviation) | ksi | Deviation | at Break | Deviation |
| CE6 | 799 | 4.761 | 0.80% | 5.934 | 0.152 | 1.49% | 0.08% |
| | (19) | (0.070) | (0.00) | | | | |
| 10 | 792 | 4.831 | 0.80% | 6.017 | 0.111 | 1.50% | 0.05% |
| | (6) | (0.072) | (0.00) | | | | |

### EXAMPLES 12-14 AND COMPARATIVE EXAMPLE C7

Powder Compositions P18-P21

Powder Compositions P18-P21, containing CNC and BN 1, were prepared using the amounts shown in Table 25 in the same manner as described for Powder Compositions P5and P6.

TABLE 25
Powder Compositions P18-P21

| | | CNC | Wt. % | Wt. % |
|---|---|---|---|---|
| Example | BN 1 (pbw) | (pbw) | BN 1 | CNC |
| P18 | 50.0 | 0.0 | 100 | 0 |
| P19 | 49.5 | 0.5 | 99 | 1 |
| P20 | 49.0 | 1.0 | 98 | 2 |
| P21 | 47.5 | 2.5 | 95 | 5 |

Curable Compositions for Examples 12-14 and Comparative Example 7

To a MAX 200 SPEEDMIXER cup were added 153.3 pbw of EPF Resin and 33.7 pbw of EC 100 Hardener. This was used to prepare curable compositions in the same manner as described for Example 4 and Comparative Example 2 using the materials and amounts shown in Table 26 with the following modification. Powder Compositions P18-P21 were employed. Curable compositions were thereby provided. The viscosity of the curable compositions was measured as described in the test method above with the following modification. A speed of 50 rpm was used. The results are shown in Table 27 below.

TABLE 26
Curable Compositions for Examples 12-14 and
Comparative Example 7

| | Resin/ | | | | |
|---|---|---|---|---|---|
| | Hardener | | | Wt. % | |
| | Formulation | Powder | Powder | Resin | Wt. % |
| Example | (pbw) | Formulation | (pbw) | Formulation | Powder |
| C7 | 85.0 | P18 | 15.0 | 85.0 | 15.0 |
| 12 | 85.0 | P19 | 15.0 | 85.0 | 15.0 |
| 13 | 85.0 | P20 | 15.0 | 85.0 | 15.0 |
| 14 | 85.0 | P21 | 15.0 | 85.0 | 15.0 |

TABLE 27
Viscosity

| | | Wt. % | | |
|---|---|---|---|---|
| | | CNC in | Brookfield | |
| | Wt. % | Filler | Viscosity | % Viscosity |
| Example | Filler | Mixture | (cP) | Decrease |
| C7 | 15 | 0 | 5,616 | 0 |
| 12 | 15 | 1 | 5,080 | 9.5 |
| 13 | 15 | 2 | 4,920 | 12.4 |
| 14 | 15 | 5 | 4,360 | 22.4 |

Cured Compositions

All molding and curing of the curable compositions prepared above was done within 12 hours of adding the hardener to the compositions. The curable compositions of Example 12 and Comparative Example 7 were used to prepare cured compositions in the same manner as described for Example 4 and Comparative Example 2. The cured compositions thus obtained were evaluated for thermal and tensile properties as described in the test methods above. The results are shown in Tables 28 and 29 below.

TABLE 28
Thermal Properties

| | | | Diffusivity | | | | |
|---|---|---|---|---|---|---|---|
| | | | square | Specific | | | |
| | | Density | millimeter/ | Heat | | | |
| | | g/cc | second | Capacity | | Thermal | |
| | Temp | (Standard | (Standard | Joules/K/ | Standard | Conductivity | Standard |
| Example | (° C.) | Deviation) | Deviation) | gram | Deviation | Watts/meter - K | Deviation |
| CE 7 | 25 | 1.232 | 0.231 | 1.278 | 0.002 | 0.36 | 0.001 |
| | | (0.001) | (0.001) | | | | |
| 12 | 25 | 1.232 | 0.229 | 1.316 | 0.007 | 0.37 | 0.003 |
| | | (0.001) | (0.001) | | | | |

TABLE 29
Tensile Properties

| | | Yield | | | | | |
|---|---|---|---|---|---|---|---|
| | Modulus | Strength | % Elongation | | | | |
| | ksi | ksi | at Yield | Tensile | | | |
| | (Standard | (Standard | (Standard | Strength | Standard | % Elongation | Standard |
| Example | Deviation) | Deviation) | Deviation) | ksi | Deviation | at Break | Deviation |
| CE 7 | 519 | 5.906 | 1.30% | 8.997 | 0.424 | 2.74% | 0.35% |
| | (0) | (0.005) | (0.00) | | | | |
| 12 | 531 | 6.073 | 1.35% | 8.232 | 0.228 | 2.13% | 0.01% |
| | (22) | (0.088) | (0.07) | | | | |

### EXAMPLES 15-18 AND COMPARATIVE EXAMPLES CE 8-CE 15

Powder Compositions P22-P33 were prepared using the amounts shown in Table 30 in the same manner as described for Powder Compositions 1-4 with the following modifications. A MAX 100 SPEEDMIXER cup was employed and the mixing speed was 2000 rpm, and is some cases no mixing was done.

TABLE 30
Powder Compositions P22-P23

| | | Prepared Using | BN | CNC | Wt. % | Wt. % |
|---|---|---|---|---|---|---|
| Example | BN Type | SPEEDMIXER | (pbw) | (pbw) | BN | CNC |
| P22 | BN 1 | No | 50.0 | 0.0 | 100 | 0 |
| P23 | BN 1 | Yes | 50.0 | 0.0 | 100 | 0 |
| P24 | BN 1 | Yes | 49.0 | 1.0 | 98 | 2 |
| P25 | BN 12 | No | 50.0 | 0.0 | 100 | 0 |
| P26 | BN 12 | Yes | 50.0 | 0.0 | 100 | 0 |
| P27 | BN 12 | Yes | 49.0 | 1.0 | 98 | 2 |
| P28 | BN 50 A | No | 50.0 | 0.0 | 100 | 0 |
| P29 | BN 50 A | Yes | 50.0 | 0.0 | 100 | 0 |
| P30 | BN 50 A | Yes | 49.0 | 1.0 | 98 | 2 |
| P31 | BN 75 | No | 50.0 | 0.0 | 100 | 0 |
| P32 | BN 75 | Yes | 50.0 | 0.0 | 100 | 0 |
| P33 | BN 75 | Yes | 49.0 | 1.0 | 98 | 2 |

Bulk Density

The bulk density of various powder compositions was determined as described in the “Bulk Density” test method above. The results are shown in Table 31 below.

Specific Surface Area

The BET specific surface area of various powder compositions was determined as described in the “Specific Surface Area” test method above. The results are shown in Table 31 below.

TABLE 31
Bulk Density and Specific Surface Area Results

| | | | | BET |
|---|---|---|---|---|
| | Powder | Bulk Density | Standard | square |
| Example | Composition | g/cc | Deviation | meters/gram |
| CE 8 | P22 | 0.079 | 0.002 | 17.0756 |
| CE 9 | P23 | 0.091 | 0.001 | 20.0533 |
| 15 | P24 | 0.096 | 0.001 | 18.2321 |
| CE 10 | P25 | 0.225 | 0.004 | 3.7825 |
| CE 11 | P26 | 0.306 | 0.006 | 3.5912 |
| 16 | P27 | 0.335 | 0.004 | 3.4118 |
| CE 12 | P28 | 0.345 | 0.004 | 2.4268 |
| CE 13 | P29 | 0.376 | 0.008 | 2.3742 |
| 17 | P30 | 0.380 | 0.004 | 2.4113 |
| CE 14 | P31 | 0.215 | 0.002 | 4.2879 |
| CE 15 | P32 | 0.257 | 0.001 | 4.5030 |
| 18 | P33 | 0.277 | 0.004 | 4.4315 |

1. A method of making a resin composition comprising
providing a mixture of boron nitride particles and cellulose nanocrystals wherein the weight ratio of boron nitride to cellulose nanocrystals ranges from 99.9:0.1 to 90:10; and
combining the mixture with a resin composition.

2. The method of claim 1 wherein the resin composition has a viscosity at least a 5, 10, 15, 20 or 25% lower than the same composition without the cellulose nanocrystals.

3. The method of claim 2 wherein the resin composition comprises at least 5, 10, 15, 20, 25, 30, 35, or 40 wt.-% of the mixture of boron nitride particles and cellulose nanocrystals.

4. The method of claim 1 wherein the mixture is a powder prepared by dry mixing the boron nitride particles and cellulose nanocrystals.

5. The method of claim 4 wherein boron nitride has a surface area of less than 25, 20, 10, 5 or 3 m²/g.

6. The method of claim 4 wherein the boron nitride has a bulk density ranging from at least 0.05, 0.01, or 0.15 g/cm³ ranging to about 0.60 g/cm³.

7. The method of claim 4 wherein the boron nitride particle size d(0.1) ranges from 0.25 to 100 microns.

8. The method of claim 4 wherein the boron nitride particle size d(0.5) ranges from about 0.5 to 200 microns.

9. The method of claim 4 wherein the boron nitride particle size d(0.9) is at least 0.5 microns ranging up to 300 microns.

10. The method of claim 1 wherein the boron nitride particles are platelets or agglomerates thereof.

11. The method of claim 1 wherein the cellulose nanocrystals have a maximum primary particle size of less than 1 micron.

12. The method of claim 1 wherein the resin comprises a thermoset resin.

13. The method of claim 12 wherein the resin comprises an epoxy resin.

14. The method of claim 1 wherein the resin composition comprises at least substantially the same thermal properties as compared to the same composition without the cellulose nanocrystals.

15. The method of claim 1 wherein the resin composition comprises at least substantially the same tensile and elongation properties as compared to the same composition without the cellulose nanocrystals.

16. A powder comprising a mixture of boron nitride particles and cellulose nanocrystals wherein the weight ratio of hexagonal boron nitride to cellulose nanocrystals ranges from 99.9:0.1 to 90:10.

17. The powder of claim 16 wherein the powder provides at least a 5 to 25% decrease in viscosity when 30 wt. % of the powder is combined with Epoxy Test Resin.

18. A composition comprising premixed boron nitride particles and cellulose nanocrystals wherein the cellulose nanocrystals are present such that the mixture provides at least a 5 to 25% decrease in viscosity when 30 wt.-% of the premixed boron nitride particles and cellulose nanocrystals are combined with Epoxy Test Resin.

19. (canceled)

20. The powder of claim 16 wherein the mixture provides at least about the same thermal properties and/or tensile and elongation properties when combined with a resin composition as compared to the same resin composition without the cellulose nanocrystals.

21. (canceled)

22. A resin composition comprising the powder of composition of claim 16.

23-28. (canceled)
